(19) United States
(12) Patent Application Publication
(10) Pub. No.: US 2010/0178479 A1
(43) Pub. Date: Jul. 15, 2010

(54) Housing Structure for 3C Products

(76) Inventor: Johnson Lee, Taoyuan Hsien (TW)

Correspondence Address: Ruay L. Ho, 1045 North Utah Street, # 502, Arlington, VA, 22201, US

(21) Appl. No.: 12/352,608

(22) Filed: Jan. 12, 2009

(51) Int. Cl. B32B 7/02

(52) U.S. Cl. 428/213

(57) ABSTRACT

A housing structure for 3C products comprises a plastic made member and a supporting plate; the member can be shaped in any of various forms by injection shaping and includes an outer surface with respect to the inner surface; the supporting plate is combined with the inner surface of the plastic made member. The bending resistive elasticity of the supporting plate is larger than the elasticity of the injection shaped member, and the thickness of the supporting plate is thinner than the thickness of the injection shaped member. The thickness of the supporting plate is between 0.08 ˜0.5 mm, the thickness and cost of the housing structure is reduced. The housing structure is provided with sufficient bending strength against external pressure exerted onto the outer surface of the injection shaped member.

### TECHNICAL FIELD

The present invention relates to a housing structure for 3C products, and more particularly to a housing structure having a plastic made member with an inner surface combined with a thin supporting plate of high elasticity against bending, thereby containing sufficient strength against bending, capable of resisting external pressure exerted onto the outer surface of the plastic made member.

### BACKGROUND

Most housing structures for 3C products of computers, electronic products and communication products seen in the market are injection molded of plastics or pressure made alloy of aluminum-magnesium for the purpose of protecting the electronic elements in the 3C products, these two types of housing structures have different advantages and defects.

As to the plastic made housing structures, they are quite cheap with respect to material cost, but having insufficient strength to bear the external pressure on the 3C products. For instance, a NB housing normally has a thickness more than 2 mm, the entire volume and weight of the housing will thus increase accordingly.

With respect to aluminum-magnesium made alloy housing structures, containing the characteristics of the metal alloy, they have sufficient strength to bear the 3C products external pressure if the thickness is more than 0.5 mm, the requirement of effectively reducing volume and weight is then fulfilled; however, due to the difficulty and high unit cost of manufacturing metal alloy, the unit cost of manufacturing housings with alloy is much higher than the unit cost of plastic molded housing structures, and material cost is much higher as well.

In view of the above, in order to solve the above stated defects, and to render the 3C product housing structures to have the bending strength bearing external pressures, and to reduce volume, weight, and production cost, the inventor of the present invention provides the present invention based on years professional experience in continuous research and development.

### SUMMARY OF THE DISCLOSURE

The primary object of the present invention is to provide a housing structure for 3C products in which a member made of low cost plastic with its inner surface combined with a surface of a thin supporting plate of high elasticity against bending. The plastic molded housing is provided with sufficient bending strength against external pressure, the thickness of the housing structure can then be reduced, and also reduce the entire volume, weight of the 3C products. The housing structure can further effectively reduce the cost of material.

In order to achieve the above stated objects, the housing structure for 3C products of the present invention comprises a plastic molded member and a supporting plate. The plastic molded member includes an inner surface with respect to the outer surface; the outer surface of the supporting plate is combined with and on top of the inner surface of the plastic made member. Among all the members of the housing structure, the supporting plate of high elasticity against bending has greater elasticity than the injection molded plastic member, the thickness of the supporting plate is thinner than the plastic made member, the thickness of the supporting plate is between 0.08˜0.5 mm.

In practice, the plastic made member is injection molded plastic member.

In practice, the thin supporting plate is either a sheet of fiber plate made of cured and set resin or a metallic thin plate.

The present invention will be apparent after reading the detailed description of the preferred embodiments thereof in reference to the accompanying drawings.

### BRIEF DESCRIPTION OF THE DRAWINGS

FIG. 1 is a perspective schematic view showing members of a preferred embodiment of a housing structure for 3C products of the present invention;

FIG. 2 is a sectional schematic view of a preferred embodiment of the present invention after assembling; and

FIG. 3 is a schematic view showing the use of a preferred embodiment of the present invention.

### DETAILED DESCRIPTION

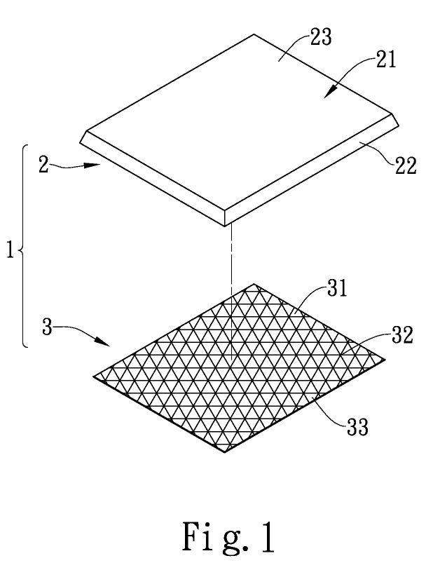

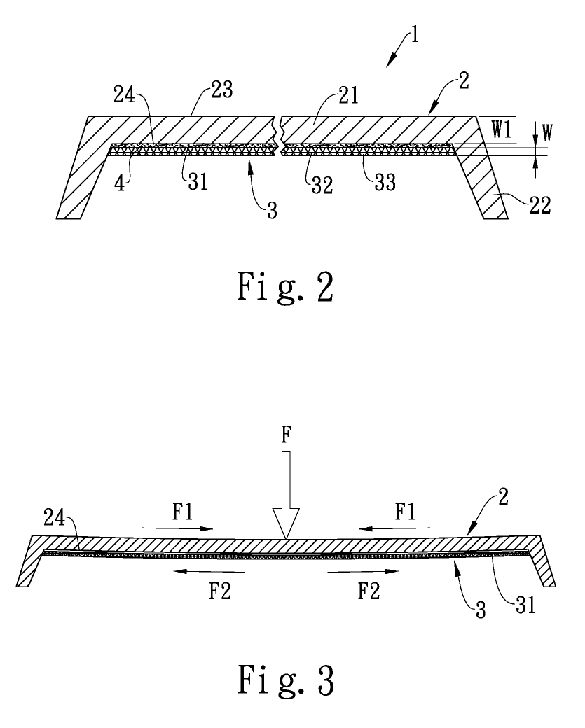

Referring to FIGS. 1 and 2, a preferred embodiment of the housing structure for 3C products of the present invention comprises a member 2 made of plastic and a supporting plate 3.

The member 2 is shaped by injection plastic and includes a rectangular panel 21 and peripheral sides 22 extending down from the rectangular panel 21, the member is used as an upper cover of a note book computer and an outer surface 23 is formed with respect to an inner surface 24. In practice, the member 2 made of plastic can be of some other shapes to be used as a structural member of various computers, electronic products, and communication 3C products to protect the inner electronic elements in the 3C products.

The supporting plate 3 is a thin plate, it can also be a plane plate having holes or uneven surface, the thickness of the supporting plate 3 is between 0.08˜0.5 mm, the thickness W of the supporting plate 3 is thinner than the thickness W1 of member 2 made of injection plastic, and the area of the outer surface 31 of the supporting plate 3 is more than half of the area of the inner surface 24 of member 2 made of injection plastic, the area of the outer surface 31 of the supporting plate 3 is preferably equal to the inner surface 24 of member 2 made of injection plastic. By utilizing an adherence agent 4, a large area of the outer surface 31 of the supporting plate 3 is glued onto the inner surface 24 of plastic molded member 2; In practice, the supporting plate 3 can be placed in a mold (not shown) in advance, by injecting from the mold, plastic molded member 2 can then be formed, the member 2 made of injection plastic can therefore be integrally combined with the supporting plate 3.

In practice, the supporting plate 3 is a fiber layer 32 pre-dipped in resin 33, then heated and pressured to form a sheet of fiber plate, said supporting plate 3 can be in shell shape, the fiber layer 32 can skip the resin 33 dipping process and be placed in a die cavity of a mold, the fiber layer 32 and the resin 33 are then added into the die cavity to be combined and cured, after the supporting plate 3 is formed, the bending resistive elasticity of the supporting plate 3 is greater than the elasticity of the injection made member 2.

Further, the fiber layer 32 is formed by braiding a plurality of glass fiber strips, the fiber layer 32 can also be braided from one or more kinds of the following fibers including: carbon fibers, glass fiber, Kevlar fibers, boron fibers, quartz fibers, nylon fibers, metallic fibers and cotton fibers. The resin 33 is epoxy resin, and can also be polyester resin, phenol resin, polybismaleimide resin or polyimide resin, thereby the fibers in the fiber layer 32 can be set after curing.

In practice, said supporting plate 3 can also be a metallic thin plate or some other thin plate with the same characteristics, the thickness W is smaller than the thickness W1 of the injection made member 2, the bending resistive elasticity is greater than the elasticity of the injection made member 2.

Now please refer to FIG. 3 showing the use of the present invention, wherein when the outer surface 23 of the injection made member 2 is pressed by an external pressure F, the plastic made member 2 will generate a contracting force F1 toward the external pressure F, meanwhile, the outer surface 31 of the supporting plate 3 will generate a stretching force F2 to shift away from the external pressure force F. Because a large area of the outer surface 31 of the supporting plate 3 of the present invention is combined with the inner surface 24 of the plastic made member 2, and the bending resistive elasticity of the supporting plate 3 is greater than the elasticity of the injection made member 2, hence, according to the principle of engineering mechanics, the supporting plate 3 has better bending resistive elasticity than the injection made member 2 and can provide a sufficient bending resistive strength to prevent indentation of the injection made member 2, thereby avoid contacting the electronic elements inside of the 3C products and retain better protection of the latter.

Therefore, the present invention has the following advantages:

The housing structure of the present invention is provided with sufficient bending resistive strength by combining a member made of low cost plastic with a thin supporting plate with high bending resistive elasticity, not only the thickness of the housing can be reduced, the entire volume and weight of the 3C products can also be reduced, the cost of material can be effectively reduced as well.

In conclusion, based on the description disclosed above, the present invention surely can get the expected objects thereof to provide a housing structure for 3C products, sufficient bending resistive strength against external pressure can be provided. Entire volume, weight and cost of material of the housing structure for 3C products can be effective reduced. Having thus described the technical process of the present invention having high industrial value, a letter patent application is therefore submitted.

What is claimed is:

1. A housing structure for 3C products comprising:
a plastic made member including an outer surface and an inner surface; and
a supporting plate, an outer surface of said supporting plate being combined with said inner surface of said plastic made member;
wherein the bending resistive elasticity of said supporting plate is larger than the bending resistive elasticity of an injection shaped member, and thickness of said supporting plate is thinner than the thickness of said injection shaped member.

2. The housing structure for 3C products as claimed in claim 1, wherein said plastic made member material is injection made of said plastic.

3. The housing structure for 3C products as claimed in claim 1, wherein area of said outer surface of said supporting plate is larger than ½ area of said inner surface of said member injection made of said plastic.

4. The housing structure for 3C products as claimed in claim 1, wherein said supporting plate is a sheet of fiber plate made of cured and set resin.

5. The housing structure for 3C products as claimed in claim 4, wherein said supporting plate is a fiber layer which is formed by braiding one or more kinds of following fibers including: carbon fibers, glass fiber, Kevlar fibers, boron fibers, quartz fibers, nylon fibers, metallic fibers and cotton fibers.

6. The housing structure for 3C products as claimed in claim 4, wherein said supporting plate is a fiber layer which is pre-dipped with resin.

7. The housing structure for 3C products as claimed in claim 1, wherein said supporting plate is a metallic plate.

8. The housing structure for 3C products as claimed in claim 1, wherein said thickness of said supporting plate is between 0.08˜0.5 mm.
